(19) United States
(12) Patent Application Publication
(10) Pub. No.: US 2020/0296068 A1
(43) Pub. Date: Sep. 17, 2020

(54) METHOD AND SYSTEM OF AN EMAIL-BASED REQUEST AND NOTIFICATION BOARD

(71) Applicants: Angelo Enlai Ngai, brooklyn, NY (US); Kostya Viktorov, brooklyn, NY (US)

(72) Inventors: Angelo Enlai Ngai, brooklyn, NY (US); Kostya Viktorov, brooklyn, NY (US)

(21) Appl. No.: 16/103,913

(22) Filed: Aug. 14, 2018

Related U.S. Application Data
(60) Provisional application No. 62/544,906, filed on Aug. 14, 2017.

(51) Int. Cl. H04L 12/58; G06F 21/62

(52) U.S. Cl. CPC H04L 51/24; H04L 51/26; G06F 21/629

(57) ABSTRACT

In one aspect, a method useful for implementing an email-based request and notification board platform includes the step of determining that a first user posts a request to an email-request board. The method includes the step of determining that a second user answers the request. The method includes the step of detecting that the first user marks the response from the second user as helpful; and awarding the second user a karma credit.

### CLAIM OF PRIORITY

This application claims priority from U.S. Provisional Application No. 62/544,906, METHOD AND SYSTEM OF AN EMAIL-BASED REQUEST AND NOTIFICATION BOARD and filed 14 Aug. 2017. This application is hereby incorporated by reference in its entirety for all purposes.

### FIELD OF THE INVENTION

This description relates to the field of electronic communications and more specifically to an email-based request and notification board.

### DESCRIPTION OF THE RELATED ART

Email-based request/notification boards are need that encourages members to proactively help other members within their group. These Email-based request/notification boards can include the values of reciprocity and helping others into the online social networking experience. Accordingly, improvements are desired that to improve the online social networking experience by enabling an email-based request/notification board to reward users helping each other by increasing the priority of the helpers own help requests in the future.

### SUMMARY

In one aspect, a method useful implementing an email-based request and notification board platform includes the step of determining that a first user posts a request to an email-request board. The method includes the step of determining that a second user answers the request. The method includes the step of detecting that the first user marks the response from the second user as helpful; and awarding the second user a karma credit.

### BRIEF DESCRIPTION OF THE DRAWINGS

FIG. 1 illustrates an example system for an email-based request and notification board, according to some embodiments.

FIG. 2 depicts an exemplary computing system that can be configured to perform any one of the processes provided herein.

FIG. 3 is a block diagram of a sample computing environs environment that can be utilized to implement various embodiments.

FIG. 4 illustrates an example process of managing email-based requests and notifications, according to some embodiments.

FIG. 5 illustrates another example process of managing email-based requests and notifications, according to some embodiments.

FIG. 6 illustrates an example process of managing email-based requests and notifications, according to some embodiments.

The Figures described above are a representative set and are not an exhaustive with respect to embodying the invention.

### DESCRIPTION

Disclosed are a system, method, and article of manufacture of an email-based request and notification board. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment of the present invention. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be implemented without one or more of the specific details, or with other methods, components, materials, and so forth. Other instances of well-known structures, materials, or operations are not shown or described in detail to avoid obscuring key aspects of the invention.

The schematic flow chart diagrams included herein are generally set forth as logical low chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the obvious sequence of the invention's processes. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Email refers to electronic messages distributed by electronic means from one computer user to one or more recipients via a network. An email address can be used to receive email, and that address is unique to the user.

Email digest is an email that is automatically generated by an electronic mailing list and which combines all exchanged emails during a time period (e.g. day, week, month, etc.) or when a volume limit is reached (e.g. every 10 or 100 messages) into one single message.

OAuth is an open standard for access delegation, commonly used as a way for Internet users to grant websites or applications access to their information on other websites but without giving them the passwords.

### Exemplary Systems

Present embodiments provide an online communication tool designed to help users to increase the number of trusted peers with whom they can meaningfully share social capital, expertise and connections within a curated group. The communication tool can include an email-based request and notification board that is designed to run out of an email digest. This eliminates the need for account/password creation as methods of user authentication. It also eliminates the need to check a third-party service in order to look for updates in one's group. The email-based request and notification board can implement a ledger system that records instances of help given, and help received by various users. The email-based request and notification board uses this record to reveal additional pathways for group members to reciprocate after receiving help. The email-based request and notification board includes various rules and methods that, rather than just being able to help other individuals who helped them directly, users can also reciprocate by helping those who helped the members who directly helped the user. For example, if user A helps user B and user C helps user A, user B can help user C to reciprocate to the group rather than only being able to help user A directly.

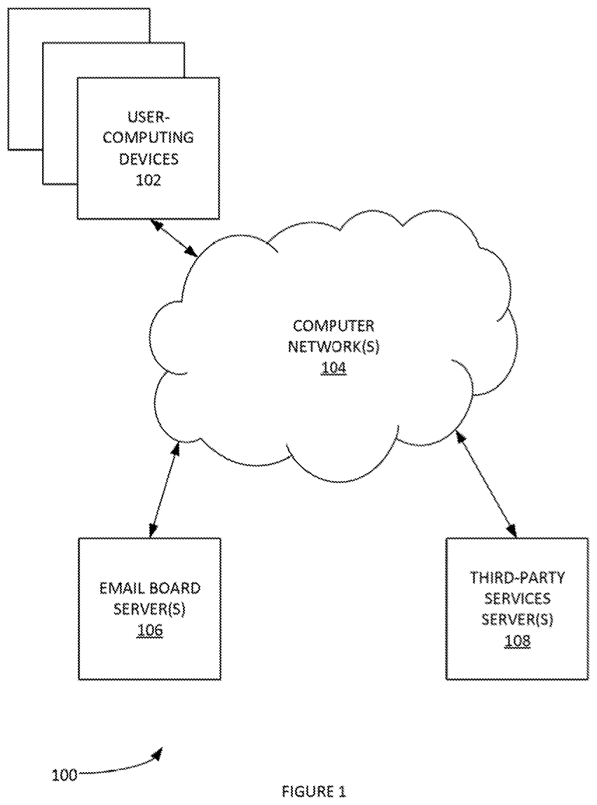

FIG. 1 illustrates an example system 100 for an email-based request and notification board, according to some embodiments. System 100 can include user computing devices 102. User computing devices 102 can include applications for accessing the email networks (e.g. web browsers, email applications, etc.). User computing devices 102 can enable users to access an email-based request and notification board via computer networks 104. Computer networks 104 can include the Internet, local-area networks, enterprise networks, cellular-data networks etc. Computer networks 104 can enable e-mail networks as well.

One or more email-based request and notification board can be maintained and managed by email board servers 106. Email board servers 106 can include web servers, email servers, databases, database management systems, search engines, etc. Email board servers 106 can implement the various email-based request and notification board processes provided infra. Email board servers 106 can also utilize third-party services serves 108 to access various functionalities (e.g. third-party email services, third-party search engines, search engine systems, ranking systems, machine-learning systems, etc.).

In one example, email board servers 106 can implement the following services. Email board servers 105 can provide various users to form into designated groups. Email board servers 106 can maintain a list of group members associated with an email-request board. The email-request board can be presented to users in the form of an email digest. Each group member can solicit the group's help and/or expertise by posting a request to a board. Email board servers 106 can enable other group members to view the request/posts via a computer-implemented user interface. Email board servers 106 can manage access to posts through various user verification methods. Email board servers 106 can gather the various user requests/posts. Email board servers 106 can generate a daily email digest of relevant user request/posts. Email board servers 106 can communicate the daily email digest to assigned users/group members. New requests/posts can be accessed by clicking a hyperlink within the daily email digest.

In some example embodiments, an email digest can be composed of three (3) key elements: a set of users; a ledger stored in an external database; and/or a communal help/notice board that operates out of the email. Whenever a group member wants to solicit the group's help they can post a request to the email-request board for all other members to see. Clicking “RESPOND” on any post in the email digest can open a new text-entry window with a record of previous responses to the post. The creator of the post receives an email update each time someone responds to their post and has the option to flag particular responses as helpful to send a unit of “karma credit” to the responder as a gesture of thanks.

Every time a member sends karma to another member, a tag is created in a back-end database of email board servers 106. For example, when user A helps user B, user A receives a tag stating: “I helped user B” and user B receives a tag stating: “user A helped me.” Opposite tags cancel each other out, so if user B were to help user A then both sets of tags would disappear (e.g. once user A has both a “I helped user B” and “user B helped me” tag this pair would disappear).

Different posts can appear on the email-request board with different levels of priority. Every group member can view the priority and order of posts on the board differently depending on their tags within the ledger. For example, if user A helped user B and user A later posts to the board requesting help, user B will see user A's post with a higher level of priority than someone with no connection to user A. It is noted that if there are other members who owe help to user A, user B can also see the posts of these members with a higher level of priority, highlighting to user B that these are members who helped user A and giving user B the chance to reciprocate user A by helping these members.

Requests in the email digest are shown to the group collectively and any member within the group can offer feedback or a solution. When the user finds a request response meaningful and/or helpful, the user can flag the response as such and in doing so award the responder a “karma′ credit.” Karma credit is best understood as a token signifying one specific user has given help to another specific user. The gradual accumulation of karma credit within a group determines how users see the priority arrangement for requests in the email digest differently. A system of karma credit can either be overt (e.g. users are explicitly made aware of the net amount of credit they are owed and owe others) or subtler (e.g. the net ledger of karma credit determines request priority in the email digest, but users do not explicitly monitor their credit quantitatively). Email board servers 106 can manage the allocation and storage of the various users' karma credits. For example, if user A provides a helpful response to user B's request, user B can provide an indication of the assistance to Email board servers 106. Email board servers 106 can then automatically send a specified amount of karma credit to user A. It is noted that if user A were to later assist user B with a request at a later time, user B could be awarded a karma credit by user A. In this example, the karma credits exchanged between the two users would cancel each other out.

Email board servers 106 can have different posts appear on the email request board with different levels of priority (e.g. top to bottom with different colors, etc.). Each group member views of the priority of various posts differently depending on their current karma credit levels. For example, if user A has received a karma credit from user B, and user A posts to the email request board requesting help, user B can see user A's post with a higher level of priority than user C. If there are other users whom A has given karma credit to then user B can also see these user's posts with a higher priority than user C (but not as high as user A). Email board servers 106 can manage this process.

It is noted that because user B can also see the request/posts members who have a unit of user A's karma credit with a higher level of priority, user B can have an opportunity to reciprocate back to user A by helping these other members. For example, user A has helped user B (e.g. via by responding to a request on the email-request board) and user C has helped user A. The applicable karma credits have been awarded to the respective users. In the event user C is posting to the email-request board requesting help/assistance, User B can see user C's post with a higher level of priority. Email board servers 106 can also provide a reminder that user B can repay user A's karma credit by helping user C with this particular request. In the event that user B then provides an adequate response to User C's request, then the karma credits of User A, User B and User C cancel each other out and email board servers 106 set the karma-credit ledger to neutral.

Groups (e.g. a wheel, etc.) can be grouped on a higher level by organizations that are themselves, collections of groups. Multiple groups can have an overarching administrator set by the organization and/or group sponsor. A group can be a collection of users connected via the processes and systems provided herein. As used herein, the term ‘group’ can also be interchanged with the term ‘wheel’ in some example embodiments.

A group can have a specified privacy setting. The privacy settings can determine the visibility of the content of a wheel to existing or not-signed in users. A public wheels can be a forward-facing group. A user does not need to be member of (and/or signed into) the email-based request and notification board platform or signed in and can view posts and responses freely.

A protected wheel can be accessible to any user already a member of the group/wheel and/or the same organization. These users can freely view posts and responses of that wheel without being a member.

A private wheel can be restricted only to members of the wheel. Other can view a name and description of wheel but not the content of wheel. A secret wheel can be visible only to an authenticated member of a sponsor organization. The secret wheel can be hidden from view unless user is a member or has been invited to the wheel.

Email-board server(s) 106 can include payment processing systems. In this way, email-based request and notification board platform can provide and manage subscriptions of users to a wheel. email-based request and notification board platform can enable user to pay to post to a specified wheel. email-based request and notification board platform can enable users to respond to posts freely in some examples.

Email-board server(s) 106 can provide different payment settings for wheels as follows. Email-board server(s) 106 can provide free wheels. In a free wheel, members are free to post and respond to posts as they wish. Email-board server(s) 106 can provide pay to groups wheels. In this wheel, members can optionally a receive a number of free posts and can respond to post for free. A user must then subscribe to the wheel when the user runs out of free posts. Subscribers can have an unlimited number of posts. Email-board server(s) 106 can provide a paid category that is subscriber only. In this category of wheels, only subscribers can post and respond. Email-board server(s) 106 can implement combinations of these categories in a wheel. For example, there can also be a post category and then a sub-category of free posts. It is noted that free and pay-to-post and paid subscription can have option payment settings in which members of the wheel can have paid categories in which members of the wheel can post at a set rate.

Email-board server(s) 106 can provide promocode functionalities. Promocodes can be granted by an administrator of a wheel. A promocode can include a subscription time where a user can view a certain amount of free subscription content for a set period (e.g. number of days, etc.). A promocode can include a post count (e.g. related to the pay to post group). This can be an allotment of free posts before have to become a subscriber to submit more posts.

Email-board server(s) 106 can provide a my-activity page for users. The my-activity can be a compilation of responses to posts, activity in posts a user is following, user mentions, etc. The my-activity page can be a compilation of new relevant info for users. The my-activity page can enable a user to following posts. The my-activity page can display posts that have received responses then receive an email notification and it is added to their my-activity page. Users can have the ability to follow up on pasts. A user can designate a post as of interest and schedule notifications when the post receives new responses.

In a response section of a set of posts, email-board server(s) 106 can provide a mentions functionality. This can target another user that is a member of the same wheel and can send that user a notice via email (e.g. this post that is sent to the user as a response is also added to the my-activity page). The Email-board server(s) 106 can link Oauth accounts (e.g. Twitter®, LinkedIn®, Gmail®, etc.) for automatic login. Users can add these to account to access the website through a front page rather than through email.

System 100 can reduce email message clutter. Email board servers 106 functionality works directly out of the email digest sent to members, with no need to create additional passwords and/or logins for user authentication. System 100 can provide services that encourage members to frequently utilize the collective resources of their group. Members do not need to feel restricted from frequently asking for help, as long as, they are willing to help others in return). System 100 connects all the users who have helped one another in such a way as there is a much larger set of options for any one user to give back to the group. System 100 can provide a system that encourages members to help one another. Helping others is rewarded by increasing the priority and credibility of one's own help requests. For example, when a user helps five (5) members of the user's group, the next time the user posts these five (5) members can see the user's request with high priority. Additionally, the other members that have received help from the five (5) members can see the user's post with high priority as well. System 100 can provide a system that builds trust. Because system 100 connects its members to one another other in terms of help given, strangers within a group can help one another with a greater degree of trust. For example, if user A helps user B and user B helps user C, even if user A and user C do not have experience helping one another, their mutual connection to user B provides a precedent for reliability.

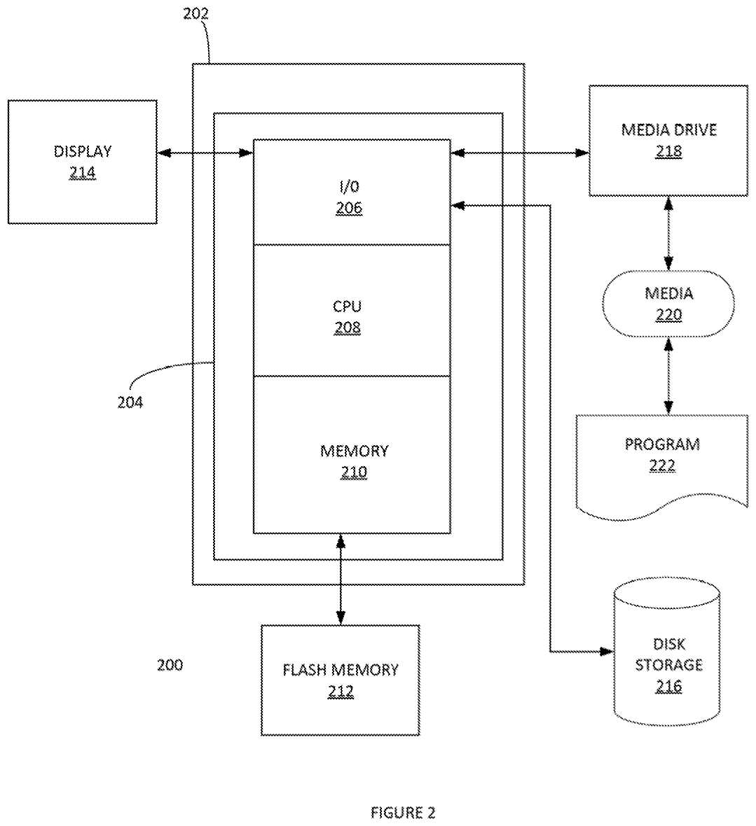

FIG. 2 depicts an exemplary computing system 200 that can be configured to perform any one of the processes provided herein. In this context, computing system 200 may include, for example, a processor, memory, storage, and I/O devices (e.g., monitor, keyboard, disk drive, Internet connection, etc.). However, computing system 200 may include circuitry or other specialized hardware for carrying out some or all aspects of the processes. In some operational settings, computing system 200 may be configured as a system that includes one or more units, each of which is configured to carry out some aspects of the processes either in software, hardware, or some combination thereof.

FIG. 2 depicts computing system 200 with a number of components that may be used to perform any of the processes described herein. The main system 202 includes a motherboard 204 having an I/O section 206, one or more central processing units (CPU) 208, and a memory section 210, which may have a flash memory card 212 related to it. The I/O section 206 can be connected to a display 214, a keyboard and/or other user input (not shown), a disk storage unit 216, and a media drive unit 218. The media drive unit 218 can read/write a computer-readable medium 220, which can contain programs 222 and/or data. Computing system 200 can include a web browser. Moreover, it is noted that computing system 200 can be configured to include additional systems in order to fulfill various functionalities. Computing system 200 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

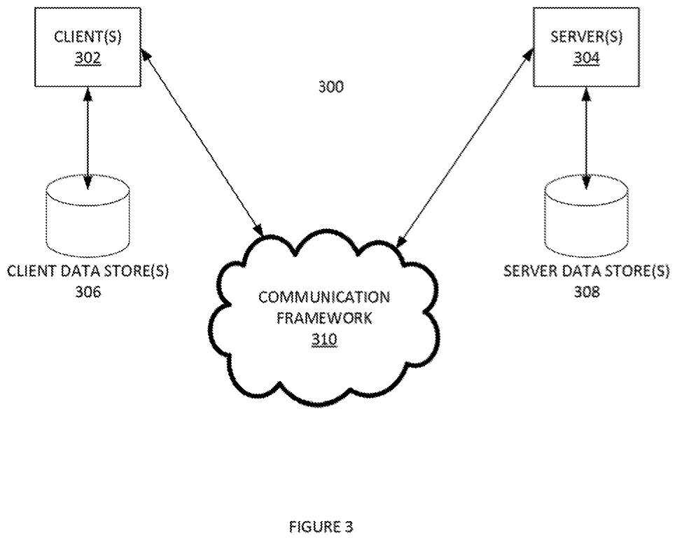

FIG. 3 is a block diagram of a sample computing environment 300 that can be utilized to implement various embodiments. The system 300 further illustrates a system that includes one or more client(s) 302. The client(s) 302 can be hardware and/or software (e.g., threads, processes, computing devices). The system 300 also includes one or more server(s) 304. The server(s) 304 can also be hardware and/or software (e.g., threads, processes, computing devices). One possible communication between a client 302 and a server 304 may be in the form of a data packet adapted to be transmitted between two or more computer processes. The system 300 includes a communication framework 310 that can be employed to facilitate communications between the client(s) 302 and the server(s) 304. The client(s) 302 are connected to one or more client data store(s) 306 that can be employed to store information local to the client(s) 302. Similarly, the server(s) 304 are connected to one or more server data store(s) 308 that can be employed to store information local to the server(s) 304. In some embodiments, system 300 can instead be a collection of remote computing services constituting a cloud-computing platform.

### Exemplary Methods

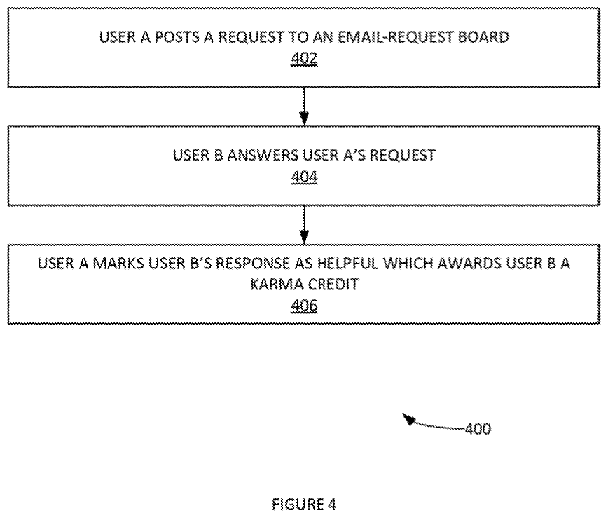

FIG. 4 illustrates an example process 400 of managing email-based requests and notifications, according to some embodiments. In step 402, user A posts a request to an email-request board. In step 404, user B answers user A's request. In step 406, user A marks user B's response as helpful which awards user B a karma credit.

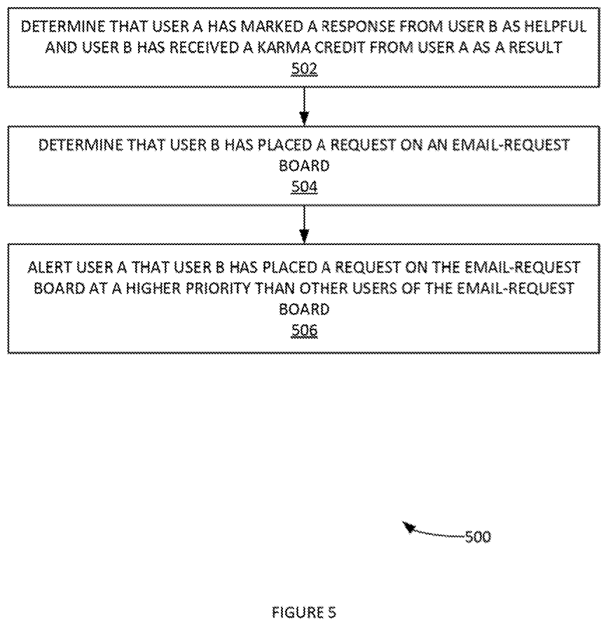

FIG. 5 illustrates another example process 500 of managing email-based requests and notifications, according to some embodiments. In step 502, process 500 can determine that user A has marked a response from user B as helpful and user B has received a karma credit from user A as a result. For example, User A can have awarded a karma credit to user B using process 400 supra. In step 504, process 500 can determine that user B has placed a request on an email-request board. In step 506, process 500 can alert user A that user B has placed a quest on the email-request board at a higher priority than other users of the email-request board. For example, process 500 can locate user B's request higher on the email digest of user A than that of other users. In another example, user A can receive an email reminder with the request by user B while posts by other users would not generate such a reminder.

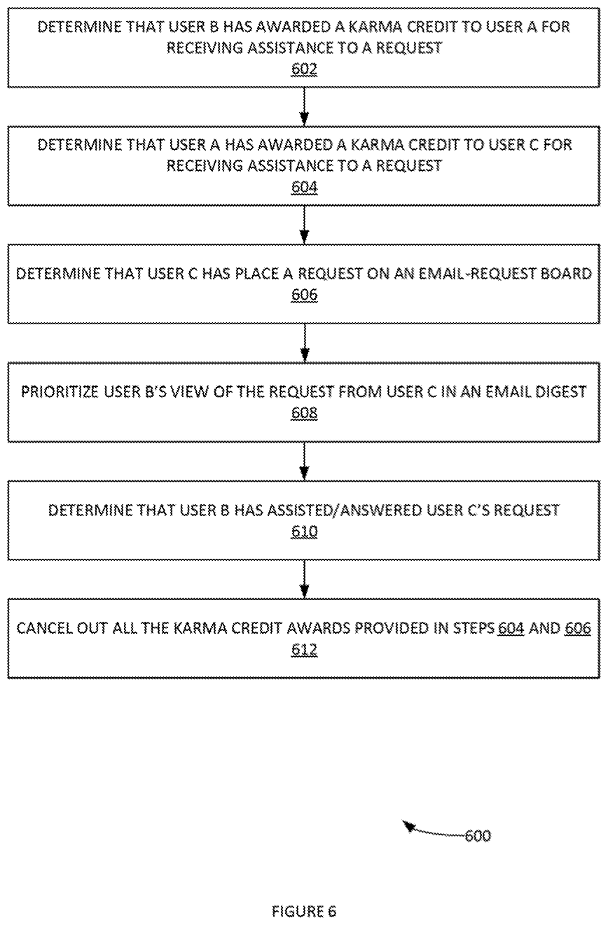

FIG. 6 illustrates an example process 600 of managing email-based requests and notifications, according to some embodiments. In step 602, process 600 can determine that user B has awarded a karma credit to user A for receiving assistance to a request. In step 604, process 600 can determine that user A has awarded a karma credit to user C for receiving assistance to a request. In step 606, process 600 can determine that user C has place a request on an email-request board. In step 608, process 600 can prioritize user B's view of the request from user C in an email digest. In step 610, process 600 can determine that user B has assisted/answered user C's request. In step 612, process 600 can cancel out all the karma credit awards provided in steps 604 and 606.

In one example of process 600, user A can have helped user B by answering a request from user B, user C can have helped user A. User C can post to the email-request board asking for help with a particular issue. User B can view user C's post with a higher level of priority and a reminder that user B helps user A by helping user C. If user B helps user C to reciprocate user A, then within the group's karma ledger user B's karma (“I helped user C” tag) can be traded for user C's karma (“I helped user A tag”). As a result, user B's “I helped user A” and “user A helped me” tags cancel out, as does user C's “I helped user B” and “user B helped me” tags. The ledger can then be reset back to neutral.

Appendix A illustrates additional information that can be utilized to implement the various systems and processes provided herein.

### Example Technical Implementation

In one example embodiment, the service can utilize a MEAN stack hosted on Amazon Web Services (and/or a similar service). The application can utilize Node.js, with user and message information stored using MongoDB®, the front-end handled by Angular, with Express as the back-end. These example services are provided by way of example and not of limitation.

In order to allow users to access their personal information, as well as public posts, in a way that doesn't require a login or authentication system, the following approach can be utilized. Each user account has a unique identifier number assigned. At the beginning of every day, a pseudorandom number, seeded with the current time, and offset by the user's identifier number, can be generated and used as the access key. The same process, but without the offset, can be repeated for the posts. URL's ending with a concatenation of these keys can allow access to profile information and posts, as well as, provide information on which user is accessing them. These unique links are provided for the users via buttons in the email digest, hosted by Mailgun® (and/or a similar service).

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A method useful for implementing an email-based request and notification board platform comprising:
determining that a first user posts a request to an email-request board;
determining that a second user answers the request;
detecting that the first user marks the response from the second user as helpful; and
awarding the second user a karma credit.

2. The method of claim 1 furthering comprising:
determining that the second user has received the karma credit from the first user; and
determining that the second user has placed a request on an email-request board.

3. The method of claim 2 further comprising:
alerting the first user that the second user has placed the request on the email-request board at a higher priority than other users of the email-request board.

4. The method of claim 3, wherein the email-request board comprises an email-request board group of users who can access the content of the email-request board and can post to the email-request board.

5. The method of claim 4, wherein the email-request board group is included in a higher-level group comprising a plurality of email-request board groups.

6. The method of claim 5, wherein the higher-level group is sponsors by a specified enterprise that administers the higher-level group.

7. The method of claim 6, wherein the email-request board group can set to a specified privacy setting.

8. The method of claim 7, wherein the specified privacy setting comprises a public setting, a private setting or a secret setting.

9. A computing system useful for implementing an email-based request and notification board platform comprising:
a processor configured to execute instructions;
a memory containing instructions that, when executed on the processor, cause the processor to perform operations that:
determine that a first user posts to an email-request board;
determine that a second user answers the request;
detect that the first user marks the response from the second user as helpful; and
awarding the second user a karma credit.

10. The computing system of claim 9, wherein the memory containing instructions that, when executed on the processor, cause the processor to perform operations that:
determine that the second user has received the karma credit from the first user; and
determine that the second user has placed a request on an email-request board.

11. The computing system of claim 10, wherein the memory containing instructions that, when executed on the processor, cause the processor to perform operations that:
alert the first user that the second user has placed the request on the email-request board at a higher priority than other users of the email-request board.

12. The computing system of claim 11, wherein the email-request board comprises an email-request board group of users who can access the content of the email-request board and can post to the email request board.

13. The computing system of claim 12, wherein the email-request board group is included in a higher-level group comprising a plurality of email-request board groups.

14. The computing system of claim 13, wherein the higher-level group is sponsors by a specified enterprise that administers the higher-level group.

15. The computing system of claim 14, wherein the email-request board group can set to a specified privacy setting.

16. The computing system of claim 15, wherein the specified privacy setting comprises a public setting, a private setting or a secret setting.
